(19) United States
(12) Patent Application Publication
(10) Pub. No.: US 2005/0219661 A1
(43) Pub. Date: Oct. 6, 2005

(54) Image forming apparatus, image forming method, and program

(75) Inventor: Kazunori Hirabayashi, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/094,797

(22) Filed: Mar. 31, 2005

(30) Foreign Application Priority Data
Apr. 1, 2004 (JP) 2004-109269

(51) Int. Cl. G06F 15/00

(52) U.S. Cl. 358/518; 358/1.9

(57) ABSTRACT

An image forming apparatus comprises a color space determining portion receives a color signal in a page description language and determines a type of a color space of the color signal, achromatic color determining portion determines whether a value of the color signal is an achromatic color depending on the type of the color space, color converting portion which, when the achromatic color determining portion determines that the color signal is an achromatic color, converts the color signal into a black monochrome color signal depending on the type of the color space, and image forming portion receives the black monochrome color signal converted and performs image forming by a black monochrome color material on recording medium, wherein printing can be performed by black monochrome color toner through converting processing of the color signal depending on the color space type.

### CROSS-REFERENCE TO RELATED APPLICATIONS

This application is based upon and claims the benefit of priority from prior Japanese Patent Application No. 2004-109269, filed Apr. 1, 2004, the entire contents of which are incorporated herein by reference.

### BACKGROUND OF THE INVENTION

1. Field of the Invention

The present invention relates to an image forming apparatus using a plurality of page description languages, and an image forming method, and particularly to an image forming apparatus and an image forming method for printing out a black image indicated by a color signal in a black monochrome color.

2. Description of the Related Art

In a conventional electrophotographic color printer, an image corresponding to an image signal is drawn in 4 colors of cyan (C), magenta (M), yellow (Y), and black (K). The components of layout can be divided into image, characters (text), and graphics (line art).

Generally, it is desirable to draw black characters or graphics in a black monochrome toner. Therefor, conventionally, a processing is performed, which interprets a PDL (Page Description Language) and forcibly replaces an input value to be converted into a black monochrome color in RIP (Raster Image Processor) which converts into a low-level drawing command (display list). For example, when an input color signal value for RIP (DeviceRGB, DeviceCMYK components) is an achromatic color (R=G=B, C=M=Y) in theory on the color space, there is a processing of replacing with only black K and outputting.

The following patent reference 1 indicates an image forming apparatus which is an electrophotographic color printer constituted of 4 colors. Specifically, it is desirable to output achromatic characters or graphics (line art) in a black monochrome color. This is because a structural deviation occurs in the electrophotographic color printer. When an achromatic object is output in composite colors of cyan, magenta and yellow, there is a problem that a drawn object looks blurred due to deviation. It is generally difficult to completely represent black with cyan, magenta and yellow, and a color which has been assumed as black cannot look black. Further, there is a problem an expensive toner is used for a portion which can be represented without a color component, which causes high cost.

In the prior art of such optical disk apparatus (Jpn. Pat. Appln. KOKAI Publication No. 2000-232588), an input color space for RIP is a color space such as DeviceRGB or DeviceCMYK, and a black monochrome color is replaced for the input color signal values such as R=G=B, C=M=Y, C=M=Y=0, and K=x, so that the image can be drawn in a black monochrome color at a low cost.

However, in the patent reference 1, since the input color space for RIP is a color space such as DeviceRGB or DeviceCMYK, and a black monochrome color is replaced only for the input color signals such as R=G=B, C=M=Y, C=M=Y=0, and K=z, there is a problem that originally achromatic characters or graphics cannot be drawn in a black monochrome color in the path of the CIE (Commission Internationale de l'Eclairage) color space (information on the color space is represented in parameters) and an image containing color components (cyan, magenta and yellow) is drawn. That is, since a network is developed in the circumstances of an recent image forming apparatus, color signals due to various color spaces are arbitrarily supplied to a printer controller or a printer from many types of user's PC.

However, there is a problem that in such circumstance, it is not possible to determine in the RIP in the printer controller a color signal of which color space a given color signal of the CIE color space is originally. Specifically, as in the prior art, when a given color signal is assumed as a color signal of a certain color space to determine an achromatic color by only the color signal value, if the type of the color space is different between forecasted one and actual one, there is a possibility that a fault occurs in printing. For example, when the color signal value of the Lab color space is assumed as the RGB based color space to determine an achromatic color, though the color space is generally an orange based color in the case of L=a=b=30, L=a=b may be erroneously determined to be an achromatic color.

### BRIEF SUMMARY OF THE INVENTION

According to an embodiment of the invention provides an image forming apparatus comprising: a color space determining portion which receives a color signal in a page description language and determines a type of a color space of the color signal; an achromatic color determining portion which determines whether a value of the color signal is an achromatic color depending on the type of the color space determined in the color space determining portion; a color converting portion which, when the achromatic color determining portion determines that the color signal is an achromatic color, converts the color signal into a black monochrome color signal depending on the type of the color space; and an image forming portion which receives the black monochrome color signal converted in the color converting portion, and performs image forming by a black monochrome color material on a recording medium.

### BRIEF DESCRIPTION OF THE SEVERAL VIEWS OF THE DRAWING

FIG. 1 is a connection diagram showing one example of a printer controller and a printer engine according to the present invention;

FIG. 2 is a conceptual diagram for explaining one example of outline of an operation of the printer controller according to the present invention;

FIG. 3 is a flowchart showing one example of the operation of the printer controller according to the present invention;

FIG. 4 is a conceptual diagram for explaining one example of outline of the operation of the printer controller according to the present invention;

FIG. 5 is a flowchart showing one example of the operation of the printer controller according to the present invention;

FIG. 6 is a flowchart showing one example of the operation of the printer controller according to the present invention;

FIG. 7 is a flowchart showing one example of the operation of the printer controller according to the present invention;

FIG. 8 is a flowchart showing one example of the operation of the printer controller according to the present invention;

FIG. 9 is a flowchart showing one example of the operation of the printer controller according to the present invention; and

FIG. 10 is a flowchart showing one example of the operation of the printer controller according to the present invention.

### DETAILED DESCRIPTION OF THE INVENTION

Hereinafter, embodiments according to the present invention will be described in detail with reference to the drawings.

An image forming apparatus according to the present invention is directed for determining a type of a color space, determining an achromatic color depending on the determined type of the color space, and drawing, in the case of an achromatic color, an achromatic object on a CIE color space by a black monochrome color.

<Image Forming Apparatus According to the Present Invention>

(Configuration)

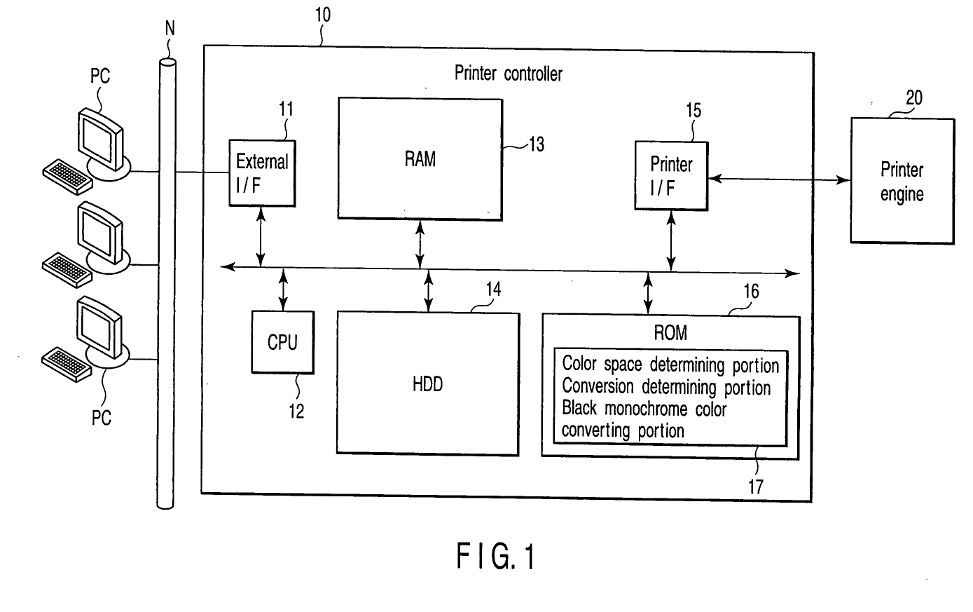

FIG. 1 is a connection diagram showing one example of a printer controller and a printer engine according to the present invention. As shown in FIG. 1, the structure of the image forming apparatus according to the present invention comprises a printer controller 10 and a printer engine 20 which is a printer itself. Further, in FIG. 1, a plurality of personal computers PC which are operated by users to supply color signals and the like in a page description language are connected to the printer controller 10 via a network N.

Here, the printer controller 10 has at least an external I/F 11 to which the personal computers PC are connected via the network N, a CPU 12 which controls the entire operation, a RAM 13 which is used as a work area or the like of image information, a HDD 14 which is used as a work area of image information or a storage of program, a printer I/F 15 connected to an external printer engine, and a ROM 17 which stores programs comprising a color space determining portion, a conversion determining portion, a black monochrome color converting portion and the like which are operation processings unique to the embodiments.

The printer controller 10 can communicate with the personal computers PC connected to the network via the external I/F 11. Further, the printer controller 10 can communicate with the printer engine 20 through the printer I/F 15,

Further, the printer engine 20, not illustrated in detail, has a laser exposing apparatus which acts as a latent image forming unit and a photosensitive drum which is rotatable as an image carrier arranged substantially at the center of the printer engine 20. The peripheral surface of the photosensitive drum is exposed by a laser beam from the laser exposing apparatus to form a desired electrostatic latent image. There are arranged around the photosensitive drum a charger which charges the peripheral surface of the drum to a predetermined charge, a developing unit which supplies a toner as a developing agent to an electrostatic latent image formed on the peripheral surface of the photosensitive drum to develop it at a desired image density, a transfer charger which transfers a toner image formed on the photosensitive drum onto a sheet, and the like.

Furthermore, an upper cassette and a lower cassette, which are pullout from the printer engine 20, respectively, are arranged in a mutually stacked manner at the bottom of the printer engine. A large-capacity feeder is provided beside these cassettes, and a sheet feeding cassette which also acts as a manual sheet tray is detachably mounted above the large-capacity feeder.

A resist roller part is provided at the upstream of the photosensitive drum. The resist roller pair corrects an inclination of a taken-out copying sheet and aligns a tip end of a toner image of the photosensitive drum and a tip end of the copying sheet to feed the copying sheet to a transfer belt at a speed identical to the movement speed of the peripheral surface of the photosensitive drum.

There is provided an operation panel for inputting various copying conditions and a copying start signal which starts an copying operation at the upper portion of the front of the printer engine 20. A liquid crystal display portion displays the number of originals or the number of copying sheets and performs display of copying magnification or edition, or various operation guides.

(Operation Outline)

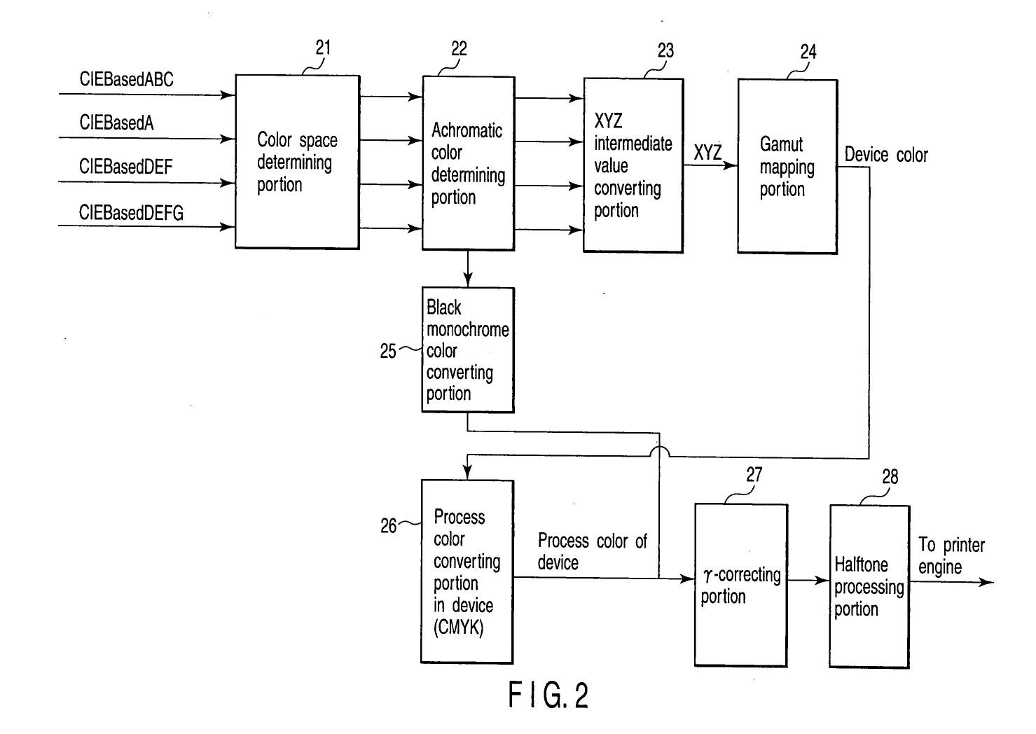

One example of outline of the operation of the image forming apparatus comprising the printer controller 10 or the printer engine 20 according to the present invention will be described below in detail using FIG. 2. The operation outline in FIG. 2 shows an outline of a processing where the CPU 12 in the printer controller 10 processes each program incorporated in the ROM 17.

At first, a PDL (Page Description Language) (PostScript level 3, PCL6) is generated using a printer driver in a personal computer PC or the like. Here, the PostScript level 3 is used to describe the example of the PostScript level 3's specification, but the present invention is not limited only to the PostScript.

Initially, a CIE color space of the PostScript supplied to the printer controller 10 from the personal computer PC or the like is roughly classified into CIEBasedA, CIEBasedABC, CIEBasedDEF, and CIEBasedDEFG as shown in FIG. 2. A, ABC, DEF, and DEFG indicate the number of original input color signal values (that is, ABC means that the number of input color signal values is 3). Specifically, CIEBasedA may be, for example, a monochrome color signal, CIEBasedABC may be, for example, RGB color space (calibrated RGB space), Lab color space, xyz color space, yuv color space or the like, CIEBasedDEF may be, for example, image signals read by a scanner, and CIEBasedDEFG may be, for example, CMYK color space or the like, and information of the color spaces is indicated by parameters.

A color signal which may be one of many color spaces is supplied to a color space determining portion 21. An achromatic color of the color signal is determined depending on the determined type of the color space in an achromatic color determining portion 22 and the determination result is supplied to a black monochrome color converting portion 23. On the other hand, the color signal is further supplied to an XYZ intermediate value converting portion 24 to be converted into an intermediate value, and further a color signal mapped in a gamut mapping portion 25 is supplied to a device process color converting portion 26.

When the color signal is determined in the achromatic color determining portion 22 to be an achromatic color, the color signal converted in the black monochrome color converting portion 25 is supplied to an output of the device process color converting portion 26, so that an achromatic color determining processing and an converting processing into a black monochrome color are enabled depending on the type of the color space. The converted color signal is supplied to a y-correcting portion 27 and a halftone processing portion 28 and is subjected to γ-correcting processing and halftone processing, and the processed signal is finally supplied to the printer engine 20.

In this manner, in the printer controller (or image forming apparatus) according to the present invention, a type of a color space of a given color signal is determined and an achromatic color is determined depending on the type, and when the color signal is determined to be an achromatic color, signal conversion is performed depending on the determined type of the color space to perform printing processing in the printer engine by a black monochrome color, for example. Thereby, it is possible that an achromatic color signal can be accurately subjected to printing processing by a black monochrome color irrespective of a type of the color space of the color signal. Therefore, even when a printing instruction is received in a page description language by various types of color space from many PCs in the network circumstances, printing by a black monochrome color can be performed for an achromatic color.

### First Embodiment

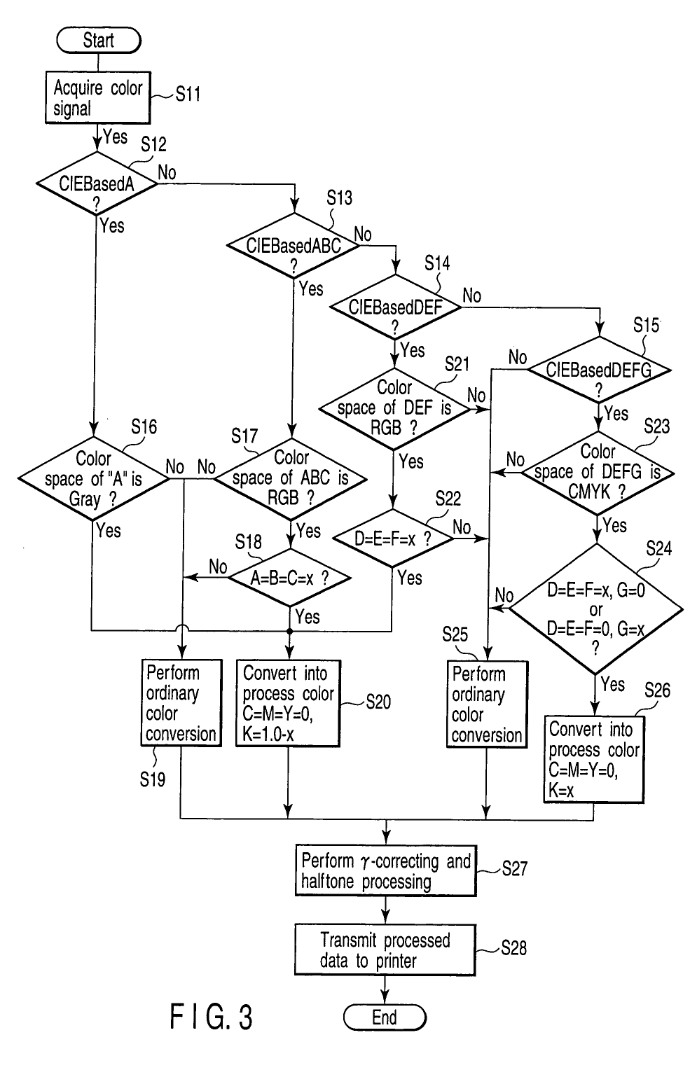

Next, a converting processing of the printer controller (or image forming apparatus) according to a first embodiment of the present invention will be described using a flowchart in FIG. 3. Initially, a color signal of the CIE color space is input from the personal computer PC or the like into the printer controller 10 which is color conversion logic for characters or graphics objects (S1). Then, the printer controller 10 determines, by the CPU 12 and programs stored in the ROM 16, which color space of CIEBasedA (S12), CIEBasedABC (S13), CIEBasedDEF (S14), or CIEBasedDEFG (S15) the type of the color space of the color signal is.

With reference to RangeABC (parameter for designating a range of the original input color signal value) of CSA (Color Space Array), in the case of RangeABC=[0, 1, 0, 1, 0, 1], the input color signal value is determined to be the RGB based color space. Alternatively, RangeABC or other parameter can be arbitrarily set in Postscript since Range of each RGB based color signal value is generally [0, 1] (arbitrarily changeable).

Since Lab color space is generally indicated as RangeABC=[0, 100, −128, 127, −128, 127], Lab color space can be determined based on this information. When the color space is determined as Lab color space, a determination is made as to whether the color space is an achromatic color. Although the achromatic color is always indicated by only L component (tone) in the Lab color space and is not strict, when there is a color signal value of L component and “a” and “b” components are both zero, the color space is determined to be an achromatic color. When the color space is determined to be an achromatic color, it is possible to perform black monochrome color processing based on the color signal value of L component. Further, it is possible to determine the input value of other color space by a similar method and make it to a black monochrome color.

Next, when the type of the color space of the color signal is CIEBasedA (S12), if the color space of “A” is gray (S16), the process color is converted into C=M=Y=0, K=1.0−x (S20). When the color space is not gray, ordinary color conversion is performed (S19). When the color space is gray, the ordinary color converting processing is bypassed so that the color converting processing whose processing time is long can be avoided, thereby reducing the entire processing time.

Next, when the type of the color space of the color signal is CIEBasedABC (S13), if the color space of ABC is RGB (S17) and A=B=C=x is established (S18), the process color is converted into C=M=Y=0, K=1.0−x (S20). If the color space is not A=B=C=x, the ordinary color conversion is performed (S19).

Next, when the type of the color space of the color signal is CIEBasedDEF (S14), if the color space of DEF is RGB (S21) and D=E=F=x is established (S22), the process color is converted into C=M=Y=0, K=1.0−x (S20). Here, the color space is not D=E=F=x, the ordinary color conversion is performed (S25).

Next, when the type of the color space of the color signal is CIEBasedDEFG (S15), if the color space of DEFG is CMYK (S23) and D=E=F=x, G=0, or D=E=F=0, G=x is established (S24), the process color is converted into C=M=Y=0, K=x (S26). When the type of the color space of the color signal is not CIEBasedDEFG (S15), or the color space of DEFG is not CMYK (S23), or D=E=F=x, G=0, or DE=F=0, G=x is not established (S24), the ordinary color conversion is performed (S25).

In this manner, in the printer controller (or image forming apparatus) according to the present invention, a type of a color space of a given color signal is determined and a determination is made as to whether the color space is an achromatic color depending on this type, when the color space is an achromatic color, the signal conversion is performed depending on the determined type of the color space to perform printing processing in the printer engine by a black monochrome color, for example.

### Second Embodiment

A second embodiment specifies a converting processing where a given color signal is initially converted in the printer controller, an achromatic color determination is made based on the converted color signal, and, in the case of an achromatic color, the color conversion is performed in a black color. Here, a color space determining processing is not performed unlike the first embodiment.

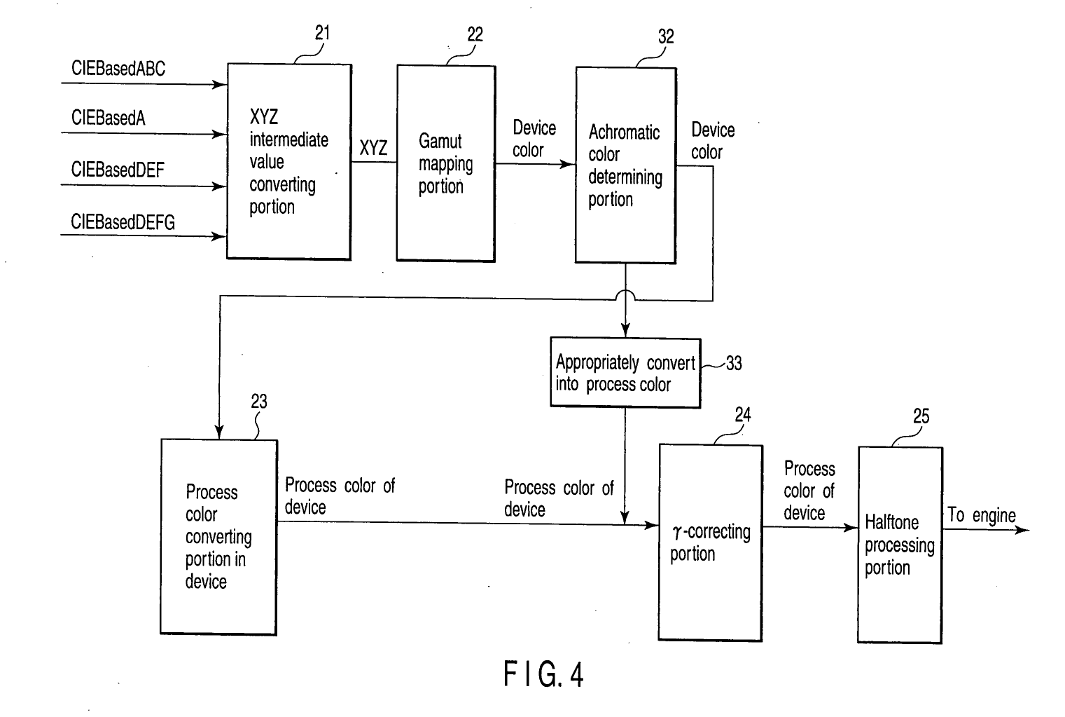

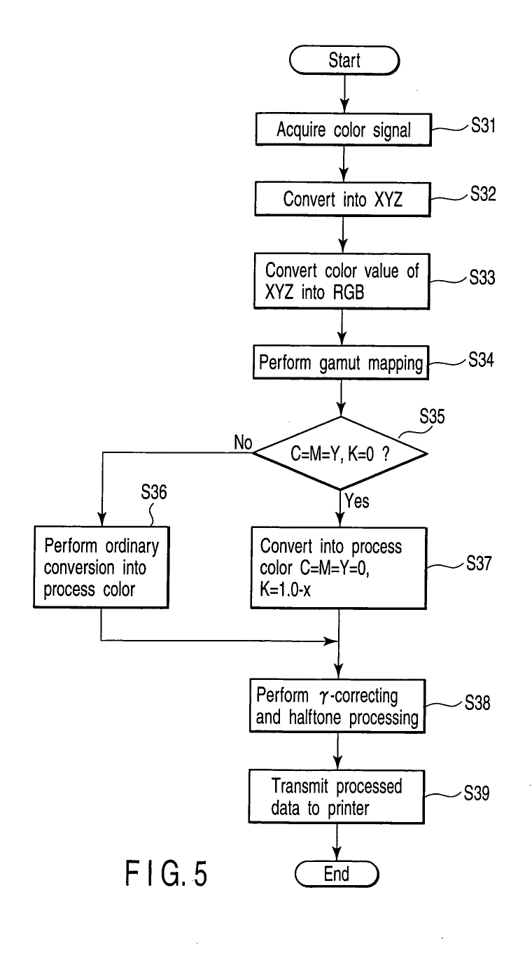

Specifically, FIG. 4 is a conceptual diagram for explaining one example of outline of the operation of the printer controller according to the second embodiment of the present invention, and FIG. 5 is a flowchart showing one example of the operation of the printer controller according to the second embodiment of the present invention.

In FIG. 4, a given color signal is supplied to the XYZ intermediate value converting portion 23 to be converted into an XYZ signal, and is subjected to mapping processing in the gamut mapping portion 24 and achromatic color determining in the achromatic color determining portion 31. Here, when the color signal is determined to be an achromatic color, it is appropriately converted into a process color in the converting portion 33, a signal combined to an output of the device process color converting portion 26 is supplied to the γ-correcting portion 27, the γ-corrected signal is supplied to the halftone processing portion 28, and the processed signal is supplied to the printer engine 20.

In the flowchart in FIG. 5, when a color signal is initially acquired in the printer controller 10 (S31), the color signal is converted into an XYZ intermediate value (S32), further the color signal of XYZ is converted into RGB (S33) and the converted signal is subjected to gamut mapping processing (S34). A determination is made as to whether the color space is C=M=Y, K=0 (S35), if not, it is converted into the ordinary process color (S26), and if yes, the process color is converted into C=M=Y=0, K=1.0−x (S37). Then, the converted signal is subjected to γ-correction and halftone processing (S38), and the processed data is supplied to the printer engine 20 (S39).

Specifically, in the second embodiment, the given color signal is initially converted, an achromatic color determination is made based on the converted signal, and, in the case of an achromatic color, the signal is replaced with a black monochrome color. Thus, the achromatic color is determined by the color signal value after color conversion, so that the achromatic color can be drawn by a black monochrome color while maintaining the effect of the color conversion.

### Third Embodiment

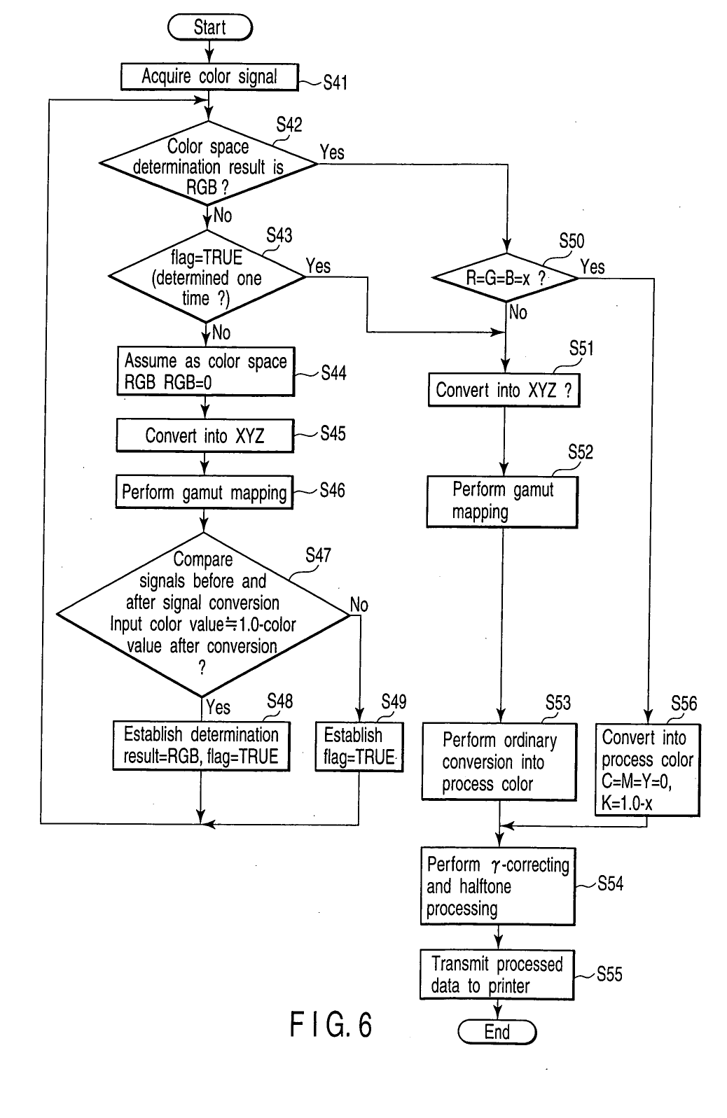

A third embodiment specifies, in the printer controller, a color space determination where a converting processing of an input color signal is performed and the signals before and after the conversion are compared to determine a type of a color space based on the signal change, and a converting processing. FIG. 6 is a flowchart showing one example of the operation of the printer controller according to the third embodiment of the present invention.

Specifically, in the third embodiment, when a color signal value of CIE color space is input into color conversion logic for characters and graphics objects, some color conversions are performed for the value of the designated color space, and the original color signal value is compared with an actually converted color signal value. Here, the third embodiment will be described by way of example of CIEBasedABC.

In the flowchart in FIG. 5, there will be described a method for, assuming that a given color signal is CIEBasedABC and a RGB based color signal, comparing the signals before and after the conversion and determining a type of a color space based on the signal change. In FIG. 5, when a color signal is input (S41), it is determined whether a color space determination result is RGB (S42), when the determination result is not RGB, a determination is made as to whether flag=TRUE has been verified (S43), and the determination result is RGB, RGB=0 is established for assuming the color space RGB (S44), and further the color signal is converted into XYZ (S45). Then, the converted signal is subjected to gamut mapping (S46).

The signals before and after the conversion are compared and a determination is made as to whether the color signal value is approximately 1.0−(value after conversion)=0, that is, whether the tone of the color signal value after color conversion is inverted (S47). If inverted, it is determined that the color space of the input color signal value is RGB and a determination result =RGB is established (S48), and if not inverted, flag =TRUE is established (S49).

When it is confirmed that the color space determination result is RGB (S42), and the R=G=B=x is established (S50), it is converted into the process color C=M=Y=0, K=1.0−x for printing in a black monochrome color.

When the color space determination result is not RGB (S42) but flag=TRUE is established (S43), the color signal is converted into XYZ (S51), and the converted signal is subjected to gamut mapping (S52) and ordinary conversion into the process color (S53). Then, the ordinary γ-correction and halftone processing are performed (S54). Thereafter, the processed data is transmitted to the printer engine (S55).

Since the color space after color conversion is generally a CMYK color space of the device and white on the CMYK color space is C=M=Y=K=0, the tone determining method in the third embodiment utilizes this difference. When some color signal values are input in the same color space by performing this processing, the processing can be performed without determining the color space for each color signal value, which causes an effect that the processing speed is fast and the color is output in a black monochrome color.

### Fourth Embodiment

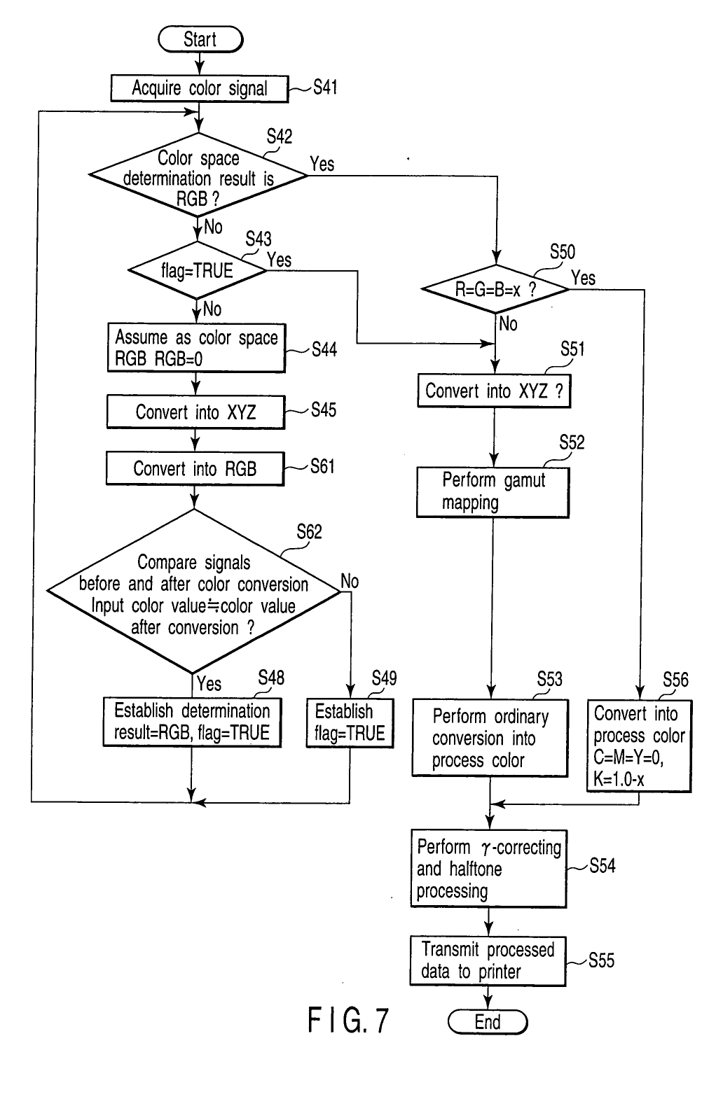

A fourth embodiment specifies, in the printer controller, a color space determination where an input color signal is converted into the XYZ color space and further into RGB to determine a type of a color space based on a signal change in the color signal values before and after the conversion, and a converting processing. FIG. 7 is a flowchart showing one example of the operation of the printer controller according to the fourth embodiment of the present invention.

In the flowchart in FIG. 7, there will be described a method for, assuming that a given color signal is CIEBasedABC and a RGB based color signal, comparing the signals before and after the conversion to determine a type of a color space based on the signal change. In FIG. 6, when a color signal is input (S41), it is determined whether the color space determination result is RGB (S42), if the determination result is not RGB, a determination is made as to whether flag=TRUE has been verified (S43), and if the determination result is RGB, the input color space is determined to be RGB and the original input color signal value is determined to be black (R=G=B=0) of RGB and white (R=G=B=1.0) of RGB (S44).

Furthermore, the color signal is converted into XYZ (S45), and the converted signal is further converted into the RGB color space (S46). When the value which has been converted by the conversion formula is identical to the input color signal value (S62), it is determined that the input color space is RGB and the determination result=RGB is established (S48), and when not inverted, flag=TRUE is established (S49). Here, in step S62, even when the values are not completely identical, it is possible to assume as the RGB space if in the range of predetermined values.

When it is confirmed that the color space determination result is RGB (S42), and the R=G=B=x is established (S50), it is converted into the process color C=M=Y=0, K=1.0−x for printing in a black monochrome color (S56).

When the color space determination result is not RGB (S24) but flag=TRUE is established (S43), the color signal is converted into XYZ (S51), and the converted signal is further subjected to gamut mapping (S52) and ordinary conversion into the process color (S53). Then, the ordinary γ-correction and halftone processing are performed (S54). Thereafter, the processed data is transmitted to the printer engine (S55).

In this manner, in the fourth embodiment, not only the conversion into XYZ but also the conversion into RGB is performed, and the type of the color space is determined by comparison between the signals before and after the conversion.

### Fifth Embodiment

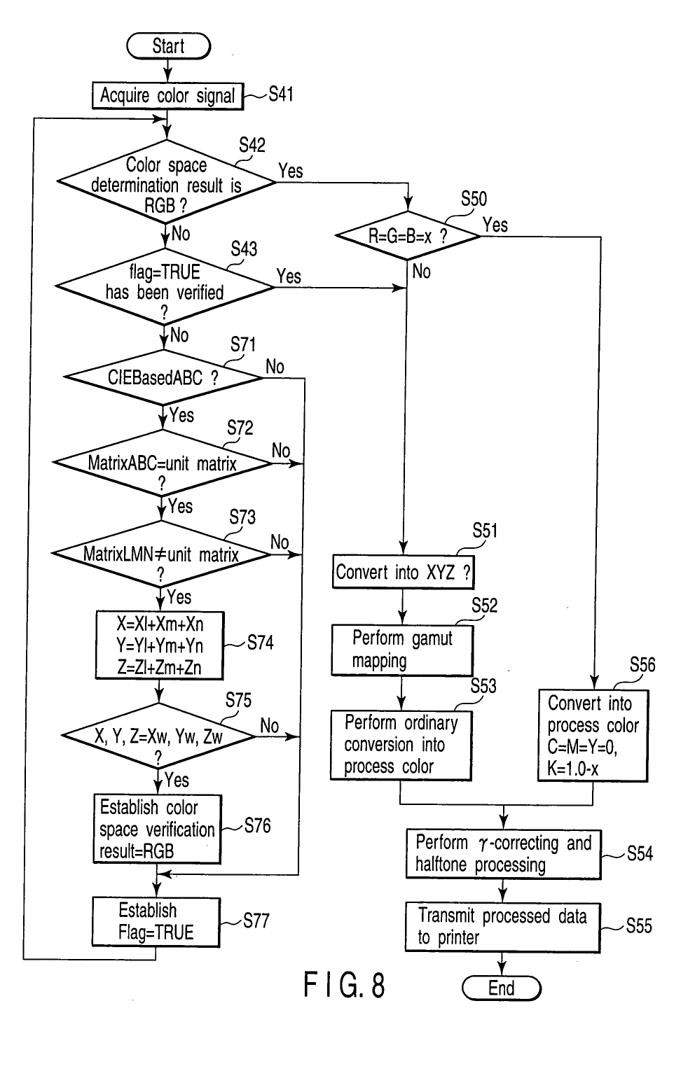

A fifth embodiment specifies, in the printer controller, a color space determination for calculating MatrixLMN or MatrixABC, which is one of the parameters of CSA indicating the characteristics of the color space, and WhitePoint to determine that an input color space is a RGB based color space, and a converting processing. FIG. 8 is a flowchart showing one example of the operation of the printer controller according to the fifth embodiment of the present invention.

In the fifth embodiment, CIEBasedABC is subjected to two-stage conversion to be converted into XYZ. Here, MatrixABC is a conversion parameter at the former stage, and MatrixLMN is a conversion parameter at the later stage. Either one conversion can be performed depending on the parameter design.

In the flowchart in FIG. 8, there will be described a method for, assuming that a given color signal is CIEBasedABC and a RGB based color signal, comparing the signals before and after the conversion to determine a type of a color space based on the signal change. In FIG. 6, when a color signal is input (S41), it is determined whether a color space determination result is RGB (S42), when the determination result is not RGB, a determination is made as to whether flag=TRUE has been verified (S43), and when the determination result is RGB, a determination is made as to whether the color space is CIEBasedABC (S71). When the color space is ABC, the value of MatrixABC of CSA in the color space is verified (S72) and the value of MatrixLMN is verified (S73). When either one Matrix is unit matrix, a parameter of Matrix which is not unit matrix is utilized to convert the input color signal value into a color signal value of the XYZ color space (S74).

R=G=B=1.0 is temporarily input as the input value at this time. Since the value which has been converted into XYZ is substantially identical to WhitePoint on the assumption that the input color space is RGB, when the value which has been converted into XYZ and WhitePoint of CSA are substantially identical (S75), the input color space is determined to be RGB from the assumption, and the color space verification result=RGB is established (S76) and Flag=TRUE is established (S77).

When it is confirmed that the color space determination result is RGB (S42) and R=G=B=x is established (S50), it is converted into the process color C=M=Y=0, K=1.0−x for printing in a black monochrome color.

When the color space determination result is not RGB (S42) but flag=TRUE is established (S43), the color signal is converted into XYZ (S51), and further the converted signal is subjected to gamut mapping (S52) and ordinary conversion into the process color (S53). Then, the ordinary γ-correction and halftone processing are performed (S54). Thereafter, the processed data is transmitted to the printer engine (S55).

In this manner, in the fifth embodiment, since MatrixLMN or MatrixABC, which is one of the parameters of CSA indicating the characteristics of the color space, and WhitePoint are calculated to determine that the input color space is the RGB based color space, and it is possible to accurately determine that the color space is the RGB space, it is possible to perform accurate converting processing without color space determination error.

### Sixth Embodiment

A sixth embodiment specifies, in the converting processing in the printer controller, a color space determination which confirms a name of a parameter of CSA indicating the characteristics of a color space and determines a type of the color space based thereon to perform color conversion, and a converting processing.

Specifically, the printer controller 10 confirms the name of a parameter of CSA given from the external I/F 11 under control of the CPU 12 and the programs stored in the ROM 16 and determines that the color space is a predetermined color space if the name is predetermined one. (sometimes the data on the names of the color spaces are stored in CSA, such as sRGB, RGB, CMYK, or Lab (color space name). When the name is clearly denoted as RGB color space, if the input value R=G=B=x (A=B=C=x) is established, the color space determination is not performed and a processing of appropriately outputting in a black monochrome color is performed. The black monochrome color processing is performed as in the above embodiments. Here, even in the case of R≈G≈B, the color space can be determined to be black). Here, since the name of the parameter of CSA is not always denoted clearly, when the color space cannot be determined from the name, any determining processing and converting processing according to the above embodiments are suitably performed.

The processing after the determination is identical to the processing after the type of the color space is determined in the flowchart in FIG. 3 according to the first embodiment, and a converting processing is appropriately performed for printing in a black monochrome color.

### Seventh Embodiment

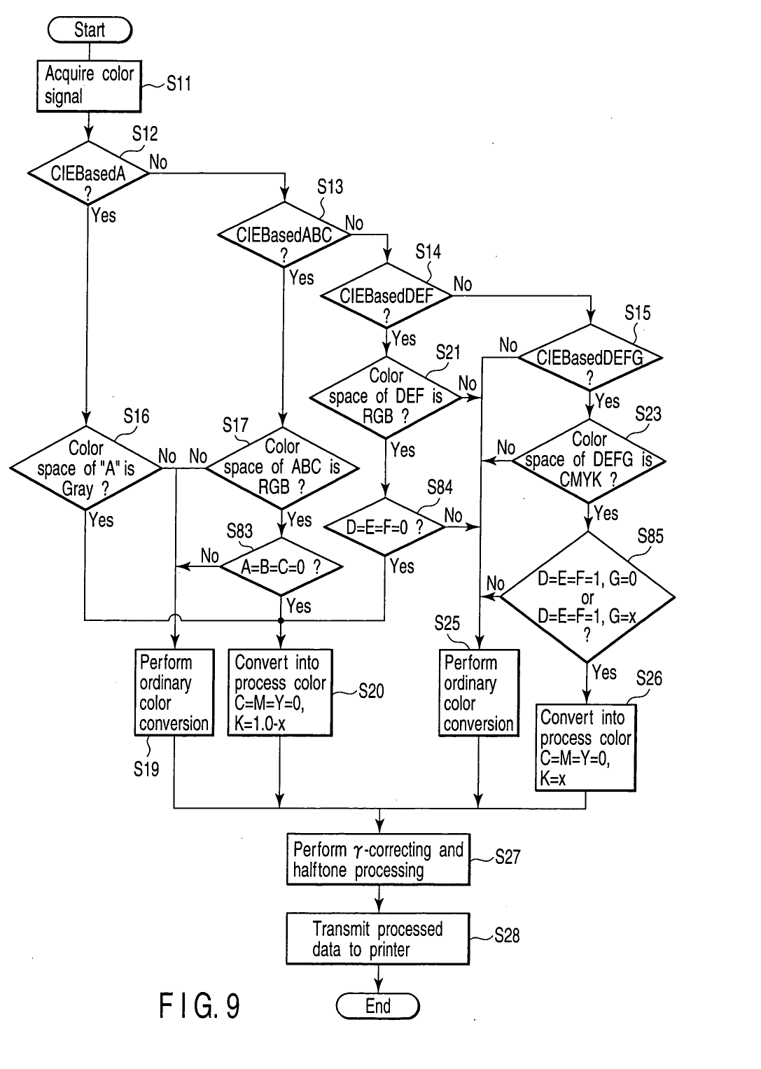

A seventh embodiment specifies the characteristics of the first embodiment and a converting processing which replaces with a black monochrome color, for example, only when a value such as R=G=B=0, C=M=Y=1 is established in determining an achromatic color for converting a color signal. FIG. 9 is a flowchart showing one example of the operation of the printer controller according to the present invention.

Although the flowchart in FIG. 9 is substantially identical to the flowchart in FIG. 3 according to the first embodiment, it is inquired in steps S83 and S84 whether A=B=C=0 is established, so that it is possible to prevent break of a gradation of intermediate tone (gray color) such as a gradation portion and black characters can be output in a black monochrome color.

### Eighth Embodiment

An eighth embodiment specifies the characteristics of the first embodiment and a processing where, by way of example of the RGB color space, the color space is determined to be an achromatic color when each component of RGB is in the range of +δ and the Lab color space is determined to be an achromatic color when the values “a” and “b” are near the achromatic color axis (when the case where “a” and “b” are zero is assumed as an achromatic color, the color space is determined to be an achromatic color in the case of “a”, “b”<δ).

Specifically, in the eighth embodiment, by way of the RGB color space in the converting processing in the printer controller, the color space is determined to be an achromatic color when each component of RGB is in the range of +δ, and the Lab color space is determined to be an achromatic color when the values “a” and “b” are near the achromatic color axis (when the case where “a” and “b” are zero is assumed as achromatic color, the color space is determined to be an achromatic color in the case of “a”, “b”<δ).

Thus, the black monochrome color processing can be performed for the color signal value which is not an achromatic color in theory but is determined as an achromatic color in human's visual, thereby enhancing the representing characteristics of achromatic characters or graphics.

### Ninth Embodiment

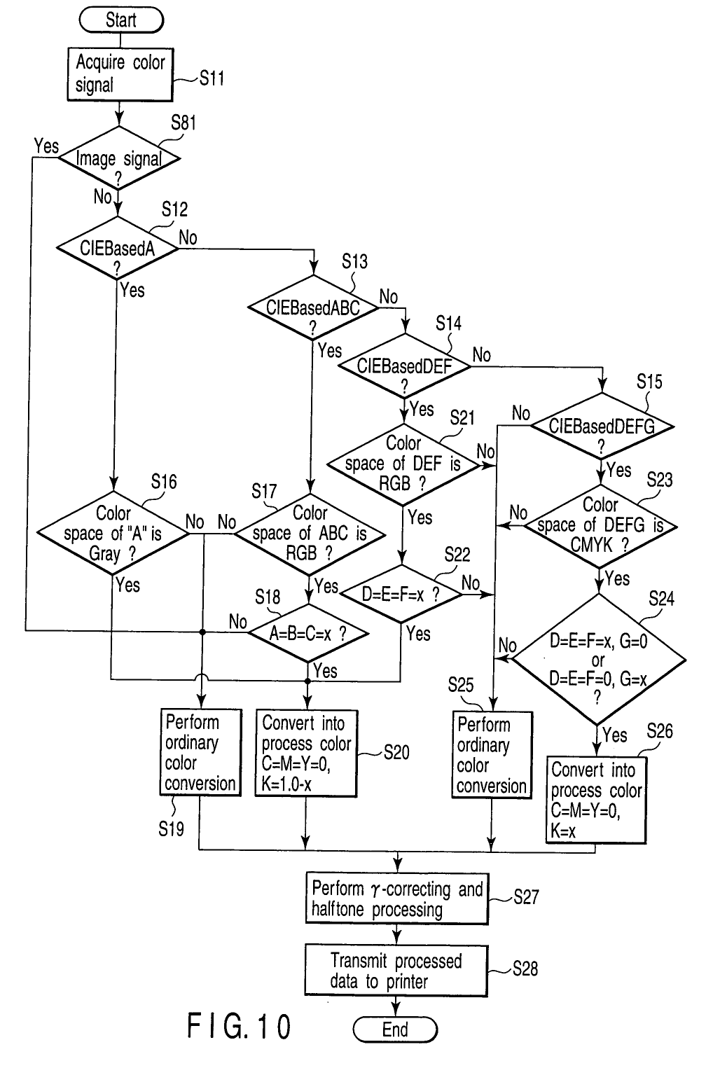

A ninth embodiment specifies the characteristics of the first embodiment and a converting processing which avoids the determining processing based on whether the color signal is an image signal or whether an operator of the color signal indicates an image. FIG. 10 is a flowchart showing one example of the operation of the printer controller according to the ninth embodiment of the present invention.

Specifically, in the flowchart in FIG. 10, a determination is made as to whether the color signal is an image signal after the color signal is acquired (S81), when it is an image signal, the processing of determining the color space is avoided and the processing advances to step S19, where the ordinary color conversion is performed (S19).

By way of example of postscript, there are a stroke operator which is an instruction of drawing a line, a fill operator which is an instruction of painting the designated range, a show operator which is an instruction of drawing a character, an instruction of drawing an image such as BMP image or Tiff image, and the like. In the ninth embodiment, the processing according to the above embodiment is not performed for the color value of an object drawn by an image operator. Although the color space determination, the achromatic color determining processing, the black monochrome color processing according to the above embodiments are performed for the color values of objects drawn by the fill operator, the stroke operator and the show operator, a condition is modified in the achromatic color determination for the operator type. For example, the achromatic color determination condition is assumed as R=G=B=x in the fill operator and the stroke operator. This is because the gradation portion will be accurately reproduced. The show operator is assumed to indicate characters, and the achromatic color determination condition described in the eighth embodiment is employed. This is because when the character object is not completely gray (R=G=B=x) but is near dray (R≈G≈B), it looks sharper in outputting in a black monochrome color.

Thus, the achromatic graphics and character objects input as CIE color are not expressed in a composite color of cyan, magenta and yellow but in a black monochrome color, which is not influenced by deviation in the electrophotographic printer.

Since the actual input color space is assumed for the CIE color space to determine an achromatic color portion, it is possible to simplify the color converting processing and to reduce the processing time. For example, even when color signals due to various types of color space are given in the network circumstances, an appropriate processing enables the optimum printing in a black monochrome color.

### Other Embodiments

In the printer controller 10 according to the present invention, a given color signal PDL is a signal whose characteristics of the color space is described in parameter in the PDL file.

In the printer controller 10 according to the present invention, a threshold value is given to a reference value in determining as an achromatic color, and it is determined as an achromatic color if it is within a certain range.

Further, in the printer controller 10 according to the present invention, the processings according to the above first to ninth embodiments can be arbitrarily changed selectively by work of the CPU 12 and the programs stored in the ROM 16. The select signal may be given from the personal computer PC via the network N, or may be given to the CPU 12 in other method. Thus, the processing of determining an optimum color space according to the situation and the color converting processing are enabled.

In the embodiment, there has been explained the case the function for implementing the present invention is previously recorded inside the apparatus, but the present invention is not limited thereto, and a similar function may be downloaded from the network into the apparatus or a recording medium on which a similar function is stored is installed in the apparatus. The recording medium may be any form of recording medium such as CD-ROM which can store programs and is readable by the apparatus. The function which can be previously obtained through installing or downloading may be realized in cooperation with the OS (operating system) inside the apparatus.

In the image forming apparatus according to the present invention, for example, a color signal in a page description language is received from a user's personal computer, and a type of a color space of this color signal is determined. Specifically, when the color space determination is not performed in a conventional apparatus, if the color space of the color signal is, for example, Lab color space, there is a problem that when the color space is determined to be the RGB color space and the achromatic color determination is made, an orange based color is erroneously determined to be an achromatic color. Therefore, in the conventional image forming apparatus, when a signal of an arbitrary type of color space is transmitted from a personal computer or the like to the printer, there is a problem that image forming in a black monochrome color cannot be performed in the case of the color signal of the color space which does not correspond to the printer driver. In the present invention, for example, the Lab color space is accurately identified by the color space determination and the achromatic color determination is performed depending on the type of the color space, and thus there is not error for the achromatic color determination.

Furthermore, when the color signal is determined to be an achromatic color, the color signal is converted into a color signal indicating a black monochrome color depending on the determined type of the color space to be output to the printer. Thus, since the achromatic color determining processing and the color converting processing are performed depending on the type of the color space in the printer, the color signal of an arbitrary type of the color space is only transmitted to the printer from a user's personal computer without being restricted by the type of the color space so that it is possible to accurately perform image forming in a black monochrome color when the color signal is an achromatic color.

Though those skilled in the art can realize the present invention from various embodiments described above, those skilled in the art can easily conceive various variants of these embodiments and can apply to various embodiments without inventive ability. Therefore, the present invention covers a wide range which does not contradict disclosed principles and novel characteristics, and is not limited to the aforementioned embodiment.

1. An image forming apparatus comprising:
a color space determining portion which receives a color signal in a page description language and determines a type of a color space of the color signal;
an achromatic color determining portion which determines whether a value of the color signal is an achromatic color depending on the type of the color space determined in the color space determining portion;
a color converting portion which, when the achromatic color determining portion determines that the color signal is an achromatic color, converts the color signal into a black monochrome color signal depending on the type of the color space; and
an image forming portion which receives the black monochrome color signal converted in the color converting portion, and performs image forming by a black monochrome color material on a recording medium.

2. The image forming apparatus according to claim 1, wherein the color space determining portion uses Range parameter of the color signal to determine a type of a color space.

3. The image forming apparatus according to claim 1, wherein the color space determining portion calculates MatrixLMN or MatrixABC, which is a parameter indicating the characteristics of the color space of the color signal, and WhitePoint and determines based on the result that the color signal is a RGB based color space.

4. The image forming apparatus according to claim 1, wherein the color space determining portion converts the color signal to be suitable for the image forming portion, compares a signal before signal conversion of the color signal and a signal after signal conversion, and determines a type of the color space depending on the comparison result.

5. The image forming apparatus according to claim 1, wherein the color space determining portion converts the color signal into an intermediate color space to be suitable for the image forming portion, compares a signal before signal conversion of the color signal and a signal after signal conversion, and determines a type of the color space depending on the comparison result.

6. The image forming apparatus according to claim 1, wherein the color space determining portion determines a type of the color space based on a name of a parameter included in the color signal.

7. The image forming apparatus according to claim 1, wherein, when the achromatic color determining portion determines that the color signal is an achromatic color before the color space determining portion determines a type of a color space, the color space determining portion does not determine a type of a color space of the color signal.

8. The image forming apparatus according to claim 1, wherein, when the color signal is determined to be an image, the color space determining portion does not determine a type of the color space.

9. The image forming apparatus according to claim 1, wherein the color space determining portion determines a type of the color space depending on a type of an operator included in the color signal.

10. The image forming apparatus according to claim 1, wherein only when the achromatic color determining portion determines that the color signal indicates only black, the color converting portion converts the color signal into a black monochrome color signal depending on the type of the color space.

11. An image forming method comprising:
receiving a color signal in a page description language and determining a type of a color space of the color signal;
determining whether a value of the color signal is an achromatic color depending on the determined type of the color space;
when the color signal is determined to be an achromatic color, converting the color signal into a black monochrome color signal depending on the type of the color space; and
receiving the converted black monochrome color signal and performing image forming by a black monochrome color material on a recording medium.

12. The image forming method according to claim 11, wherein the color space determining uses Range parameter of the color signal to determine a type of a color space.

13. The image forming method according to claim 11, wherein the color space determining calculates MatrixLMN or MatrixABC, which is a parameter indicating the characteristics of the color space of the color signal, and WhitePoint and determines that the color signal is a RGB based color space depending on the result.

14. The image forming method according to claim 11, wherein the color space determining converts the color signal to be suitable for a device for the image forming, compares a signal before signal conversion of the color signal and a signal after signal conversion, and determines a type of the color space depending on the comparison result.

15. The image forming method according to claim 11, wherein only when the achromatic color determining portion determines that the color signal indicates only black, the color converting portion converts the color signal into a black monochrome color signal depending on the type of the color space.

16. A program which is installed in a storage area in a printer controller and is processed in an information processing portion to realize the following functions comprising:
receiving a color signal in a page description language and determining a type of a color space of the color signal;
determining whether a value of the color signal is an achromatic color depending on the determined type of the color space; and
when the color signal is determined to be an achromatic color, converting the color signal into a black monochrome color signal depending on the type of the color space.

17. The program according to claim 16, wherein the color space determining uses Range parameter of the color signal to determine a type of a color space.

18. The program according to claim 16, wherein the color space determining calculates MatrixLMN or MatrixABC, which is a parameter indicating the characteristics of the color signal, and WhitePoint, and determines that the color signal is a RGB based color space based on the result.

19. The program according to claim 16, wherein the color space determining converts the color signal to be suitable for a device for the image forming, compares a signal before signal conversion of the color signal and a signal after signal conversion, and determines a type of the color space depending on the comparison result.

20. The program according to claim 16, wherein only when the achromatic color determining determines that the color signal indicates only black, the color converting converts the color signal into a black monochrome color signal depending on the type of the color space of the color signal.
